(19) United States
(12) Patent Application Publication
(10) Pub. No.: US 2004/0212925 A1
(43) Pub. Date: Oct. 28, 2004

(54) Disc device

(75) Inventor: Norio Yoshikawa, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/801,567

(22) Filed: Mar. 17, 2004

(30) Foreign Application Priority Data
Apr. 25, 2003 (JP) 2003-121580

(51) Int. Cl. G11B 23/02

(52) U.S. Cl. 360/132

(57) ABSTRACT

An HDD has a raised portion including a substantially circular pattern. The pattern includes first to third arcuate stepped portions. The first stepped portion opposes the outer periphery of the disc. The second stepped portion is located inside the first stepped portion and closer to a disc than the first stepped portion. The second stepped portion is included in the second stepped portion and located closer to the disc than the second stepped portion. The first to third stepped patterns extend through a certain angle in a position deviated from the movement route of a magnetic head over the disc.

### CROSS-REFERENCE TO RELATED APPLICATIONS

This application is based upon and claims the benefit of priority from prior Japanese Patent Application No. 2003-121580, filed Apr. 25, 2003, the entire contents of which are incorporated herein by reference.

### BACKGROUND OF THE INVENTION

1. Field of the Invention

The present invention relates to a disc device for recording and reproducing information, with a head opposed to a disc rotating in a sealed case.

2. Description of the Related Art

A disc drive 100 with a top cover 112 having a structure for suppressing distortion due to external force is known as a conventional disc device (see, for example, U.S. Pat. No. 6,351,344 B1; Summary and FIGS. 4 and 5). In this disc drive, distortion of the top cover due to external force is suppressed to prevent the top cover from contacting discs or the motor that rotates the discs.

The top cover is attached to the base of the disc drive via a plurality of fixing portions located at the perimeter. The base contains heads, a controller, etc., used for reading data from a disc, as well as the motor for rotating the discs.

To enhance the rigidity, the top cover has a first indented portion 124, a second indented portion 126 closer to the discs than the first indented portion, and a raised portion 128 remoter from the discs than the first indented portion. The first indented portion occupies substantially the entire surface of the top cover except for the perimeter. The raised portion is formed circular and concentric with the axis of rotation of the discs. The second indented portion is formed arcuate around the raised portion.

However, this top cover is not rigid enough to mount the disc drive into a portable device, such as a notebook personal computer (PC). For instance, the top cover may well be pressed and distorted when the disc drive is mounted in a notebook PC and the keyboard is operated.

If the top cover is distorted, it may contact components, such as the motor, contained in the base. In this state, dust occurs and sticks to heads or discs, which disables data reading.

Moreover, if the top cover is distorted into contact with a disc, it may damage part of or the entire disc, thereby destroying part of or the entire information recorded thereon. At worst, the disc drive itself is destroyed.

Further, if the top cover contacts a rotating disc or disc clamper, the rotational speed of the disc may abruptly change and stop without retracting the head to the outside of the disc. When the head is stopped over the disc surface, it may be electro-magnetically attached thereto, causing the disc drive to be completely inoperable.

### BRIEF SUMMARY OF THE INVENTION

In accordance with one embodiment of present invention, there is provided a highly reliable disc device having a sufficiently rigid top cover.

According to an aspect of the embodiment of the invention, there is provided a disc device comprising: a disc; a driving section configured to support and rotate the disc; a head configured to record and reproduce information onto and from the disc; and a case containing the disc, the driving section and the head, the case including: a case main unit having an opening; and a cover secured to the case main unit, closing the opening and opposing the disc, and the cover including: a first arcuate stepped portion opposing an outer periphery of the disc; a second arcuate stepped portion located closer to the disc than the first stepped portion; and a second arcuate stepped portion located closer to the disc than the second stepped portion.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 is an exploded perspective view schematically illustrating the structure of a hard disc drive (HDD) according to an embodiment of the invention;

FIG. 2 is a plan view illustrating the top cover of the HDD appearing in FIG. 1;

FIG. 3 is a sectional view illustrating the HDD of FIG. 1;

FIG. 4 is a graph showing variations in the distortion ratio of the top cover obtained when the height difference ratio of the stepped portions of the top cover are varied;

FIG. 5 is a graph variations in the distortion ratio of the top cover obtained when the width ratio of the stepped portions of the top cover are varied;

FIG. 6 is a plan view illustrating a top cover in which a stepped control portion is provided along the entire periphery of a first stepped portion; and

FIG. 7 is a sectional view illustrating an HDD with the top cover shown in FIG. 6.

### DETAILED DESCRIPTION OF THE INVENTION

An embodiment in which the invention is applied to a hard disc drive (hereinafter referred to as an “HDD”) 1 as a disc device will be described in detail with reference to the accompanying drawings.

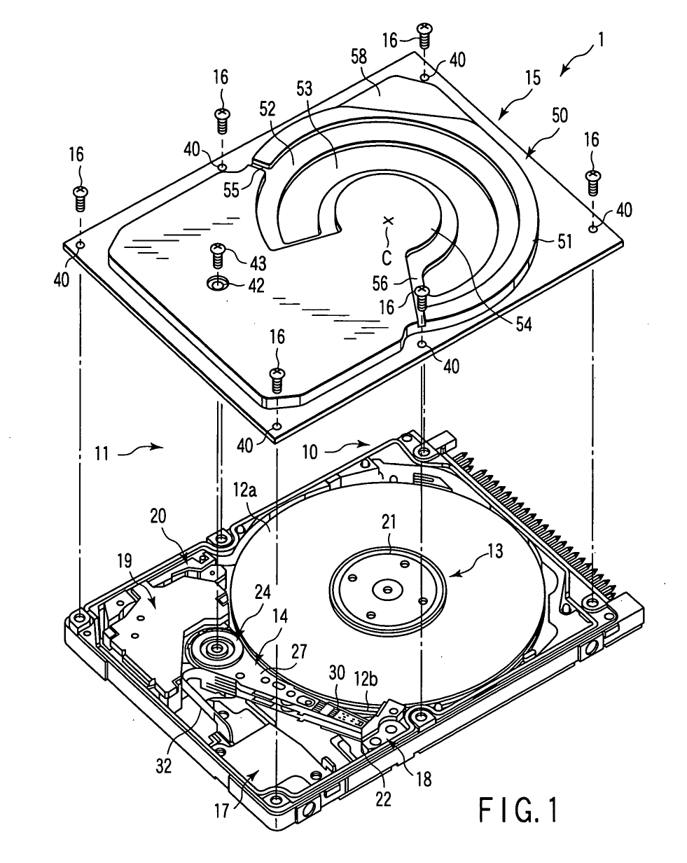

As seen from FIG. 1, an HDD 1 has a substantially rectangular sealed, case 11. The case 11 comprises a substantially rectangular box-shaped main unit 10 with an upper opening, and a substantially rectangular top cover (lid member) 15. The top cover 15 is screwed to the case main unit 10 by a plurality of screws 16, thereby sealing its upper opening.

The case main unit 10 contains two magnetic discs 12a and 12b (discs) as magnetic recording members, a spindle motor 13 (driving section) for supporting and rotating the magnetic discs, and a plurality of magnetic heads 22 (heads) for recording and reproducing information to and from the magnetic discs. The unit 10 further contains a head actuator 14, a voice coil motor (hereinafter referred to as a “VCM”) 19, ramp loading mechanism 18 (holding mechanism) and inertia latch mechanism 20 and flexible printed circuit board unit (hereinafter referred to as an “FPC unit”) 17. The head actuator 14 supports the magnetic heads so that they can move over the magnetic discs 12a and 12b. The VCM 19 rotates and positions the head actuator 14. The ramp loading mechanism 18 holds the magnetic heads in a retracted position away from the position in which the heads are positioned above the magnetic discs, when the heads are moved to the outermost peripheries of the discs. The ramp loading mechanism 18 further prevents the peripheries of the magnetic discs from moving in a direction parallel to the surfaces of the discs. The inertia latch mechanism 20 holds the head actuator 14 in a retracted position. The FPC unit 17 is provided with circuit components, such as a preamplifier.

A printed circuit board (not shown) for controlling the operations of the spindle motor 13, VCM 19 and magnetic heads 22 via the FPC unit 17 is screwed to the outer surface of the case main unit 10, opposing the bottom of the case 10.

The magnetic discs 12a and 12b have a diameter of, for example, 48 mm (1.8 inches) and upper and lower surfaces serving as magnetic recording layers. The discs 12a and 12b are concentrically mounted around the hub (not shown) of the spindle motor 13 and clamped by a clamp spring 21 such that they are stacked with a certain space therebetween along the axis of the hub. The discs 12a and 12b are rotated by the spindle motor 13 at a predetermined speed.

The head actuator 14 comprises a bearing assembly 24 fixed to the bottom of the case 10, four arms 27 attached to the bearing assembly 24, and four magnetic head assemblies 30 supported by the respective arms 27. Each magnetic head assembly 30 includes a slim suspension formed of a plate spring, and a corresponding magnetic head 22 fixed to the suspension.

Each magnetic head 22 is electrically connected to the FPC unit 17 via the arms 27, a relay flexible printed circuit board (not shown) attached to the surface of the suspension, and a main flexible circuit board 32.

During the operation of the HDD 1, the head actuator 14 is swung by the VCM 19 to substantially radially move over the magnetic discs 12a and 12b to a target track thereon.

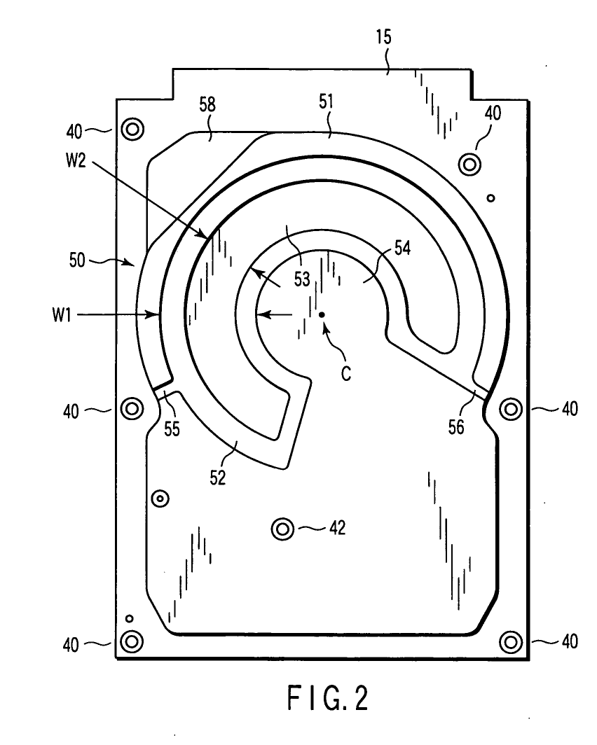

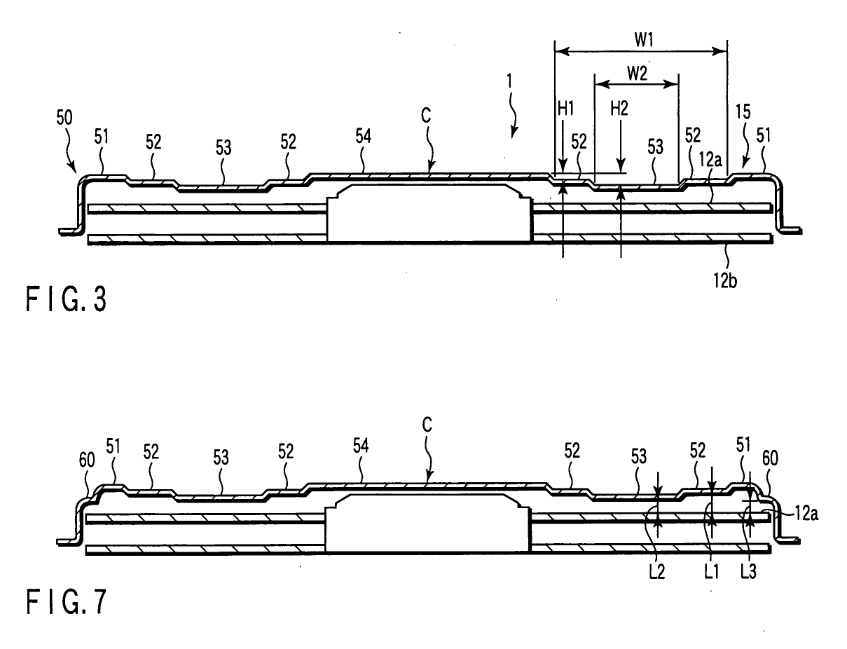

On the other hand, the substantially rectangular top cover 15 is obtained by press-forming an iron (SPCC rolled steel, stainless steel, etc.) plate with a thickness of, for example, about 0.25 mm. FIG. 2 is a plan view of the top cover 15, and FIG. 3 is a sectional view of the HDD 1, taken along the line passing through the center C of the magnetic disc. The configuration of the top cover 15 will now be described.

Through holes 40 are formed in the four corners of the top cover 15 and substantially central portions of the two long sides of the same. The top cover 15 is fixed to the case main unit 10 by screwing screws 16 through the holes 40 into screw holes formed in the unit 10. In this state, the top cover 15 blocks the upper opening of the unit 10, opposing the magnetic disc 12a substantially parallel with a predetermined space therebetween. Thus, the sites including the through holes 40 form fixing sections for fixing the top cover to the case main unit 10.

Further, the top cover 15 has another through hole 42 in a position corresponding to the bearing assembly 24. By screwing a fixing screw 43 into the upper end of the bearing assembly 24 through the hole 42, a part of the top cover 15 is coupled to the assembly 24.

The top cover 15 is press-formed such that its greater part, except for the perimeter with the six through holes 40, provides an outwardly and upwardly (in FIG. 1) raised portion. More specifically, the top cover 15 has a raised portion 50 that occupies the greater part of the surface of the top cover, except for the perimeter. The raised portion 50 includes a substantially circular pattern that almost surrounds the two magnetic discs 12a and 12b (hereinafter collectively called a disc 12).

The substantially circular pattern is formed concentric with a central portion C opposing the center of the disc 12, having substantially the same diameter as the disc 12. The pattern has first to third arcuate stepped portions 51 to 53 and a fourth substantially circular stepped portion 54. The first arcuate stepped portion 51 opposes the outer periphery of the disc 12. The second arcuate stepped portion 52 is located adjacent to and inside the first stepped portion 51. The third arcuate stepped portion 53 is completely included in the second stepped portion 52. The fourth stepped portion 54 is located adjacent to and inside the second stepped portion 52. In this embodiment, the first and fourth stepped portions 51 and 54 have the same height, and the fourth stepped portion 54 is continuous with the portion of the raised portion 50 other than the substantially circular pattern. The first stepped portion 51 is separated from the other portion of the raised portion 50 by grooves 55 and 56 described later.

With reference to the height of the first and fourth stepped portions 51 and 54, the second stepped portion 52 is formed closer to the disc 12, and the third stepped portion 53 is formed closer still to the disc 12. In other words, the first and fourth stepped portions 51 and 54 are highest, the second stepped portion 52 is second highest, and the third stepped portion 53 is lowest. Further, the first to third stepped portions 51 to 53 are formed concentric, opposing the disc 12, in a position deviated from the movement route of the magnetic heads 22. The first to third stepped portions 51 to 53 extend through at least 180°. In this embodiment, the first to third stepped portions 51 to 53 are extended through as large angle as possible in a position deviated from the movement route of the magnetic heads 22. The fourth stepped portion 54 is located so that it does not interfere with the hub (not shown) of the spindle motor around which the disc 12 is mounted.

Two grooves 55 and 56 are provided which isolate the first stepped portion 51. The grooves 55 and 56 radially extend from the corresponding through holes 40 (for fixing the top cover 15 to the case main unit 10) toward the central portion C that opposes the center of the disc 12. The grooves 55 and 56 are formed at the same level as the second stepped portion 52. The groove 56 defines one end of each of the second and third stepped portions 52 and 53.

A stepped control portion 58 for suppressing vibration of the periphery of the disc 12 in a direction parallel to the surface of the disc 12 is provided in a position diametrically opposing the ramp loading mechanism 18 with respect to the disc 12. The stepped control portion 58 cuts out part of the first arcuate stepped portion 51. The inner surface of the stepped control portion 58 is brought into contact with the periphery of the disc 12 when the disc 12 vibrates in the direction parallel to its surface. The stepped control portion 58 cooperates with the ramp loading mechanism 18 diametrically opposing it to suppress the vibration of the disc 12. As a result, the disc 12 is prevented from being destroyed by a great impact that occurs, for example, when the HDD 1 is dropped.

As described above, in the embodiment, the raised portion 50 that comprises the substantially circular stepped portion 54 and the three arcuate stepped portions 51 to 53 provided around the stepped portion 54 enhances the rigidity of the top cover 15, thereby suppressing distortion of the top cover when an external force is applied thereto. This imparts sufficient rigidity to the HDD 1 and hence enables the HDD 1 to be mounted in a portable device, such as a notebook PC. This also prevents the top cover 15 from contacting the internal components of the HDD 1, thereby preventing the previously stated occurrence of dust, damage of the disc 12, excessive load on the motor, etc. As a result, the reliability of the HDD 1 can be enhanced.

Furthermore, the grooves 55 and 56 employed in the embodiment, which radially extend toward the central portion C from the fixing portions for fixing the top cover 15 to the case main unit 10, enhance the resistance of the top cover 15 to an external force exerted thereon.

The rigidity of the top cover 15 of the embodiment depends upon the radial widths W1 and W2 (see FIG. 2) of the second and third stepped portions 52 and 53, the height difference H1 (see FIG. 3) between the second stepped portion 52 and the first (fourth) stepped portion 51 and second stepped portion 52, and the height difference H2 (see FIG. 3) between the first and third stepped portions 51 and 53.

In other words, the rigidity of the top cover 15 can be enhanced by appropriately setting W1, W2, H1 and H2. The values W1, W2, H1 and H2, which enhance the rigidity, will be described.

As seen from FIG. 3, the height of the fourth stepped portion 54 of the top cover 15 is substantially determined from the height of the hub of the spindle motor 13 for rotating the disc 12. Further, is the height of the third stepped portion 53 that is closest to the upper disc 12a is predetermined. Accordingly, the height difference H2 between the fourth stepped portion 54 (first stepped portion 51) and the third stepped portion 53 is substantially unique to the HDD 1.

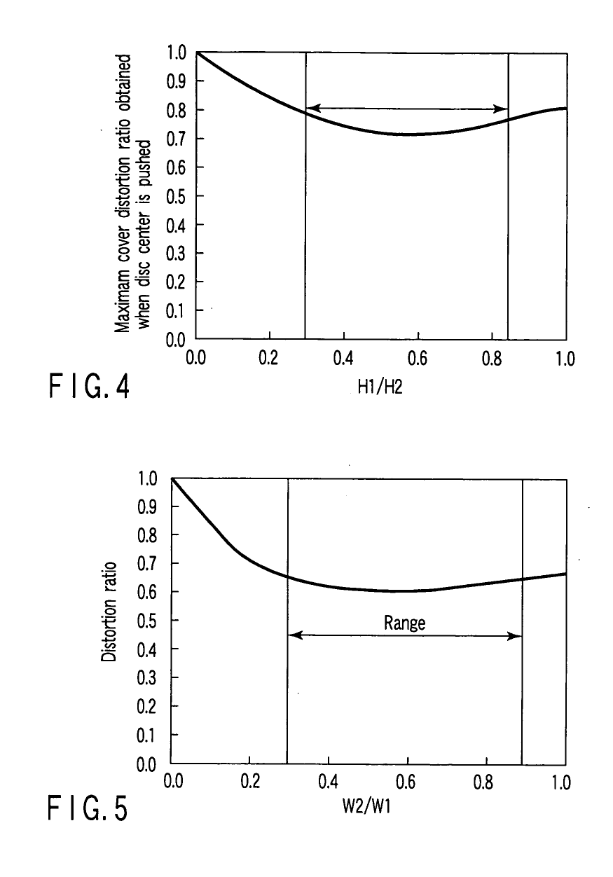

In light of this, the rigidity of the top cover 15 was calculated while varying the height difference H1 between the first and second stepped portions 51 and 52, with the height difference H2 unchanged. FIG. 4 shows the results. In the simulations, the maximum distortion ratio of the top cover 15 obtained when the central portion C was pressed by a predetermined pressure was considered the rigidity of the top cover. Further, the distortion ratio was considered to be 1 if the height difference H1 was 0.

It is understood from FIG. 4 that the maximum distortion ratio of the top cover 15 can be reduced to a value less than 0.78 if the ratio (H1/H2) of the height difference H1 to the height difference H2 is set to 0.3 to 0.85. In this H1/H2 range, the maximum distortion ratio of the top cover is higher than the minimum one only by 8%.

In particular, if there is no second stepped portion 52 (H1/H2=0) as in the previously stated conventional disc drive (U.S. Pat. No. 6,351,344 B1), the maximum distortion of the top cover 15 exceeds 0.18 mm, which means that the top cover does not have satisfactory rigidity.

To determine the optimal W2/W1 ratio for enhancing the rigidity of the top cover 15, the distortion ratio of the top cover 15 was calculated, while varying the width W1 of the second stepped portion 52 and the width W2 of the third stepped portion 53. FIG. 5 shows the results. In this case, it was assumed that the distortion ratio was 1 when width W2 was 0.

It is understood from FIG. 5 that the maximum distortion ratio of the top cover can be reduced to a value less than 0.65 if the ratio (W2/W1) of width W1 to width W2 is set to 0.3 to 0.9. In this W2/W1 range, the maximum distortion ratio of the top cover is higher than the minimum one only by 8%.

In particular, if there is no third stepped portion 53 (W2/W1=0) as in the previously stated conventional disc drive (U.S. Pat. No. 6,351,344 B1), the maximum distortion ratio of the top cover 15 reaches 1.0, which means that the top cover does not have satisfactory rigidity.

As described above, to enhance the rigidity of the top cover 15, it is sufficient if the ratio (H1/H2) of the height difference H1 between the first and third stepped portions 51 and 53 to the height difference H2 between the first and second stepped portions 51 and 52 is set to 0.3 to 0.85. Simultaneously or alternatively, it is sufficient if the ratio (W2/W1) of the radial width W2 of the third stepped portion 53 to the radial width W3 of the second stepped portion 52 is set to 0.3 to 0.9.

The invention is not limited to the above-described embodiment, but may be modified in various ways without departing from the scope. Further, various inventions can be realized by appropriately combining structural elements disclosed in the embodiment. For instance, some of the structural elements disclosed in the embodiment may not be employed.

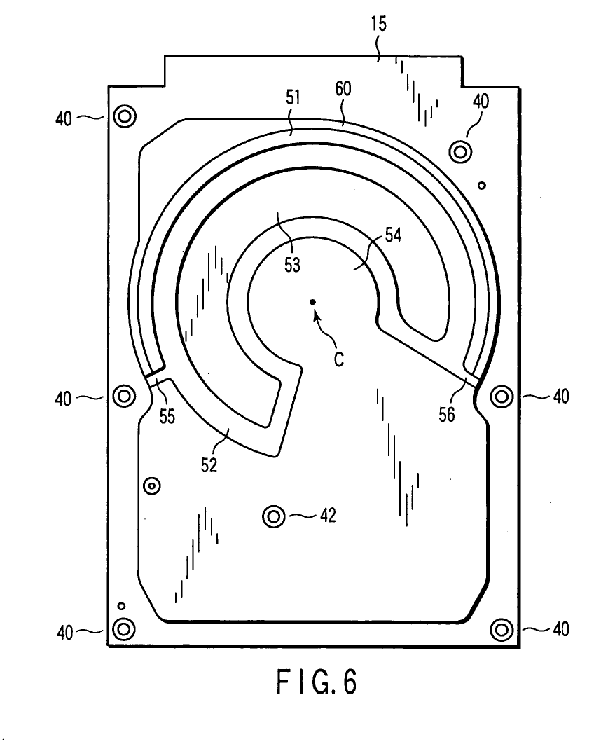

Further, the above-described embodiment employs the stepped control portion 58 that diametrically opposes the ramp loading mechanism 18. However, instead of the stepped control portion 58, an arcuate stepped control portion 60 as shown in FIG. 6 may be employed. The stepped control portion 60 extends along the entire outer periphery of the first arcuate stepped portion 51. In this case, like the stepped control portion 58, the stepped control portion 60 is also positioned closer to the disc 12 than the third stepped portion 53 as shown in FIG. 7. The thus-constructed stepped control portion 60 can suppress the vibration of the disc 12 along substantially the entire periphery of the disc 12, thereby preventing the destruction of the disc 12 in an even more reliable manner.

Since the stepped control portion 60 is thus located closer to the disc 12 than the third stepped portion 63, if an external impact is received by the HDD 1 when it is operating or stopped, the top cover 15 is prevented from contacting the disc 12 at the level of the third stepped portion 53. In other words, destruction of the disc 12 can be prevented by setting the heights of the stepped portions to satisfy the following relationship:

L3<L2<L1

where L1 represents the distance between the surface of the disc 12a and the second stepped portion 52, L2 the distance to the third stepped portion 53, and L3 the distance to the stepped control section 60.

What is claimed is:

1. A disc device comprising:
a disc;
a driving section configured to support and rotate the disc;
a head configured to record and reproduce information onto and from the disc; and
a case containing the disc, the driving section and the head,
the case including:
a case main unit having an opening; and
a cover secured to the case main unit, closing the opening and opposing the disc, and
the cover including:
a first arcuate stepped portion opposing an outer periphery of the disc;
a second arcuate stepped portion located closer to the disc than the first stepped portion; and
a second arcuate stepped portion located closer to the disc than the second stepped portion.

2. The disc device according to claim 1, wherein the first to third stepped portions concentrically extend through at least 180° away from a movement route of the head, opposing the disc.

3. The disc device according to claim 2, wherein the second stepped portion is provided inside the first stepped portion, and the third stepped portion is included in the second stepped portion.

4. The disc device according to claim 3, wherein the a fourth substantially circular stepped portion is provided inside the second stepped portion, the fourth stepped portion opposing a hub used to attach the disc to the driving section.

5. The disc device according to claim 4, wherein the fourth stepped portion has substantially a same height as the first stepped portion.

6. The disc device according to claim 3, wherein a ratio of a height difference between the first and second stepped portions to a height difference between the first and third stepped portions falls within a range of 0.3 to 0.85.

7. The disc device according to claim 3, wherein a ratio of a radial width of the second stepped portion to a radial width of the third stepped portion falls within a range of 0.3 to 0.9.

8. A disc device comprising:
a disc;
a driving section configured to support and rotate the disc;
a head configured to record and reproduce information onto and from the disc; and
a case containing the disc, the driving section and the head,
the case including:
a case main unit having an opening; and
a cover secured to the case main unit, closing the opening and opposing the disc, and
the flat cover including:
a first arcuate stepped portion opposing an outer periphery of the disc;
a second arcuate stepped portion located closer to the disc than the first stepped portion;
a second arcuate stepped portion located closer to the disc than the second stepped portion;
a plurality of fixing sections used to fix the cover to the case main unit; and
at least one groove radially extending from a portion of the cover near one of the fixing sections toward a central portion of the cover opposing a center of the disc.

9. The disc device according to claim 8, wherein the first to third stepped portions concentrically extend through at least 180° away from a movement route of the head, opposing the disc.

10. The disc device according to claim 9, wherein the second stepped portion is provided inside the first stepped portion, and the third stepped portion is included in the second stepped portion.

11. The disc device according to claim 10, wherein a ratio of a height difference between the first and second stepped portions to a height difference between the first and third stepped portions falls within a range of 0.3 to 0.85.

12. The disc device according to claim 10, wherein a ratio of a radial width of the second stepped portion to a radial width of the third stepped portion falls within a range of 0.3 to 0.9.

13. The disc device according to claim 8, wherein the groove is formed at substantially a same level as the second stepped portion.

14. A disc device comprising:
a disc;
a driving section configured to support and rotate the disc;
a head configured to record and reproduce information onto and from the disc; and
a case containing the disc, the driving section and the head,
the case including:
a case main unit having an opening; and
a cover secured to the case main unit, closing the opening and opposing the disc, and
the cover including:
a first arcuate stepped portion opposing an outer periphery of the disc;
a second arcuate stepped portion located closer to the disc than the first stepped portion;
a second arcuate stepped portion located closer to the disc than the second stepped portion; and
a stepped control portion located closer to the disc than the third stepped portion, the stepped control portion suppressing vibration of the outer periphery of the disc in a direction parallel to a surface of the disc.

15. The disc device according to claim 14, wherein the first to third stepped portions concentrically extend through at least 180° away from a movement route of the head, opposing the disc.

16. The disc device according to claim 15, wherein the second stepped portion is provided inside the first stepped portion, and the third stepped portion is included in the second stepped portion.

17. The disc device according to claim 16, wherein a ratio of a height difference between the first and second stepped portions to a height difference between the first and third stepped portions falls within a range of 0.3 to 0.85.

18. The disc device according to claim 16, wherein a ratio of a radial width of the second stepped portion to a radial width of the third stepped portion falls within a range of 0.3 to 0.9.

19. The disc device according to claim 17, wherein the cover further comprises:
a plurality of fixing sections used to fix the cover to the case main unit; and
at least one groove radially extending from a portion of the flat cover near one of the fixing sections toward a central portion of the cover opposing a center of the disc.

20. The disc device according to claim 14, wherein the stepped control portion is formed arcuate along an outer periphery of the first stepped portion.

21. The disc device according to claim 14, wherein the stepped control portion diametrically opposes a holding mechanism with the disc interposed therebetween, the holding mechanism being used to hold the head in a retracted position deviated from a position in which the head is positioned above the disc.
